(19) United States
(12) Patent Application Publication
(10) Pub. No.: US 2023/0284832 A1
(43) Pub. Date: Sep. 14, 2023

(54) MANAGEMENT SYSTEM FOR HERBS

(71) Applicant: The Violina Syndicate, LLC, Long Beach, CA (US)

(72) Inventor: Eitam Scharf, Dallas, TX (US)

(73) Assignee: The Violina Syndicate, LLC, Long Beach, CA (US)

(21) Appl. No.: 17/690,783

(22) Filed: Mar. 9, 2022

(51) Int. Cl. A47J 42/40; A47J 42/34; B65D 51/30

(52) U.S. Cl. CPC A47J 42/40; A47J 42/34; B65D 51/30

(57) ABSTRACT

A storage container for tobacco, spices and herbs has an airtight lid with a storage cavity on top for temporary storage of ground particulates. The cavity has ramp for dispensing ground material in a controlled manner, and a removable cover plate with a built-in grinder for grinding the stored material and allowing it to fall directly into the cavity. A recessed storage compartment on the bottom of the lid holds a humidity stabilizer which controls the humidity inside the container to help preserve material stored in the container. A rotary grinder can also be removably attached to the storage container.

### BACKGROUND

This invention relates generally to storage containers, and more particularly has reference to a storage container specifically designed for storing tobacco, spices and other herbs in a manner that will prolong and usability and facilitate ease of use.

Storage containers for tobacco, spices and herbs are well known. Grinders for refining tobacco, spices and other herbs are also known.

However, a problem exists in the art, in that each of those functions typically requires a separate grinding tool or storage device. Ground herbs typically include fine particulates which may blow away during transfer from the grinding device to a point of usage. Also, herb that is left in storage for too long may become stale or moldy, alternatively, may desiccate and lose its taste or aroma.

There is a need in the art for an improved system for managing the storing of fresh herbs, spices and tobacco products over long periods of time and for managing and facilitating the grinding and handling of ground particles. The present invention addresses these and other needs.

### SUMMARY OF THE INVENTION

Briefly, and in general terms, the present invention relates to a new type of storage container for tobacco, spices and herbs that it multi-functional and has a variety of built-in features for storing, grinding and dispensing ground material from a single compact and integrated product.

In some embodiments, the invention includes a jar with an airtight lid for storing the aforementioned materials inside the jar.

In some embodiments, a storage cavity is provided in the upper surface of the lid for temporary storage of ground material. The cavity may be provided with a ramp for facilitating the dispensing of ground material from the cavity.

In some embodiments, a removable cover plate is provided to at least partially cover the opening to the cavity. A grinding area on the cover plate allows herbs to be ground on the plate and ground particles to fall through openings in the grinder for collection in the cavity.

In some embodiments, the grinding plate is replaced by rotary grinding mechanism.

In some embodiments, a recessed storage compartment is provided on the bottom of the lid for removably holding a small humidity stabilizer, which acts to prolong the freshness and quality of material stored in the jar.

In some embodiments, the system includes a storage container having an opening for accessing an interior chamber of the container, a portion of the container having an exterior surface that defines a cavity, the cavity having an opening and a generally concave shape with a floor and a sidewall, and further including a removable grinder attached to the container to at least partially close the opening to the cavity and allow ground material to fall into the cavity.

In some embodiments, the storage container includes a removable lid having an upper portion and a lower portion, the lower portion of the lid having a size that can fit snugly inside the opening of the container to form a seal, the upper portion of the lid having an upper surface that defines said cavity, and further including a removable cover plate configured to at least partially close the opening to the cavity, the cover plate including said grinder for grinding herb material.

In some embodiments, the removable cover plate is configured to rest in an annular recess on the upper surface of the lid.

In some embodiments, the cavity has an outward notch, smaller in area than the cavity, extending down the sidewall toward the floor to define a sloping ramp for dispensing material out of the cavity.

In some embodiments, the cover plate has an inward notch in an edge of the plate which aligns with the outward notch in the cavity to form a space for receiving a user's fingertip to allow the user to grip the cover plate with his fingertip and remove the cover plate from the lid.

In some embodiments, at least one magnet is embedded in the lid for holding the cover plate in a secure position.

In some embodiments, a plurality of holes is provided in the cover plate to allow ground herb to fall through the cover plate into the cavity.

In some embodiments, a seal ring or gasket surrounding the lower portion of the lid provides an airtight seal between the lid and the container.

In some embodiments, the lower portion of the lid has a lower surface with a recessed compartment sized to receive a humidity stabilizer, and a removable retainer plate sized to at least partially cover the recessed compartment is provided, the retainer plate being removably attachable to the lower portion of the lid by at least one magnet embedded in the lower portion of the lid.

In some embodiments, a rotary grinder is removably attached to container. In some embodiments, the rotary grinder is removably attached to the container by mating screw threads on the container and grinder.

In some embodiments, the storage container is a wide-mouth glass jar. In some embodiments, the lid is made of wood, and the cover plate is made of metal.

In some embodiments, the system includes a storage container having an open end and a closed end, with screw threads provided around the open end, and a rotary grinder having an upper portion and a lower portion with screw threads provided around the lower portion of the rotary grinder for engaging with the screw threads on the open end of the storage container to permit the rotary grinder to be removably attached to the open end of the storage container.

These and other features and advantages of the invention will become more apparent from the following detailed description, considered in conjunction with the accompanying drawings, which illustrate by way of example, features of the invention.

### BRIEF DESCRIPTION OF THE DRAWINGS

FIG. 1 is a perspective view of a first embodiment of the invention.

FIG. 2 is an exploded perspective view of the embodiment shown in FIG. 1.

FIG. 3 is a sectional view of the embodiment shown in FIG. 1, taken substantially along the line 3-3 in FIG. 1.

FIG. 4 is a top plan view of the embodiment shown in FIG. 1, with the cover plate removed to expose the interior of the lid.

FIG. 5 is a bottom plan view of the lid shown in FIG. 4.

FIG. 6 is bottom plan view of the lid shown in FIG. 5, with the humidifier retaining plate removed to expose the interior of the lid.

FIG. 7 is a perspective view of the lid shown in FIG. 6, with the humidifier retaining plate removed to show the interior of the humidifier storage compartment.

FIG. 8 is side elevational view of a second embodiment for the lid.

FIG. 9 is a top view of the lid shown in FIG. 8.

FIG. 10 is a perspective view of the lid shown in FIG. 8.

FIG. 11 is an exploded perspective view, as seen from above, of the lid shown in FIG. 8.

FIG. 12 is an enlarged sectional view of the lid shown in FIG. 8, taken substantially along the line 12-12 in FIG. 9.

FIG. 13 is an exploded perspective view, as seen from below, of the lid shown in FIG. 8.

### DETAILED DESCRIPTION OF THE PREFERRED EMBODIMENTS

In the following detailed description, certain preferred embodiments are described which include various features of the present invention.

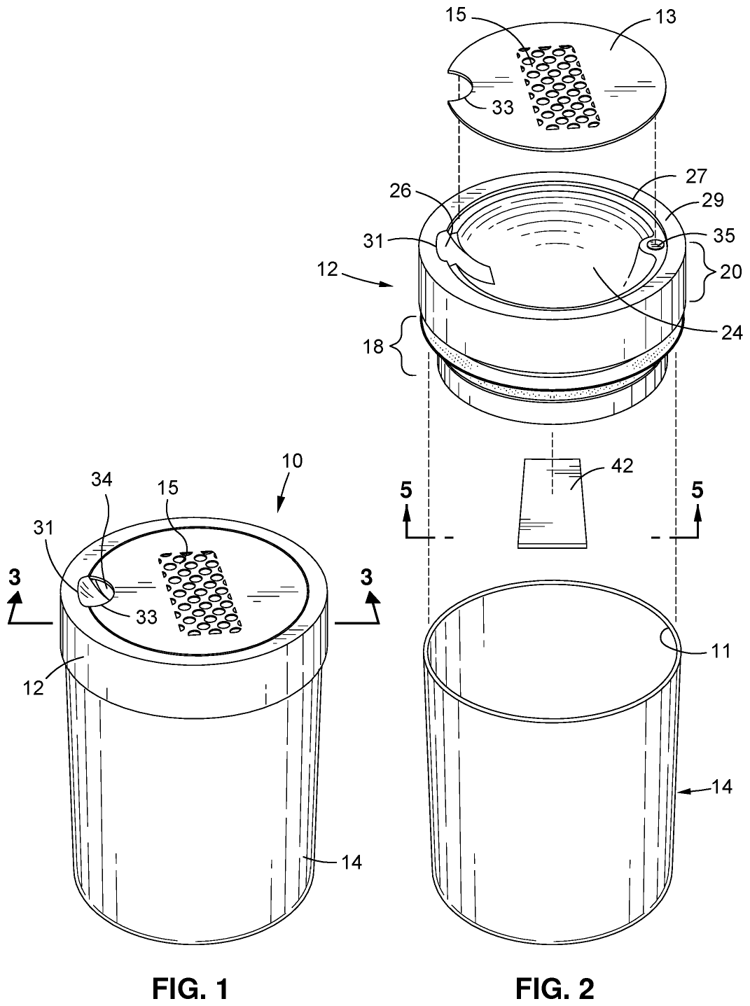

FIG. 1 shows a first embodiment of the invention, a management system for herbs 10, which takes the form of a storage container 14 with a removable lid 12, each preferably possessing, at least in part, the same outer cylindrical profile. While the preferred shape is cylindrical, it will be appreciated by those of ordinary skill in the art, that other shapes are possible.

The storage container 14 is preferably a wide-mounted jar or similar vessel (as best shown in FIG. 2), made of glass, metal, plastic or another material, and typically having an interior chamber, used for storing a supply of tobacco, spices, herbs or other consumables in a manner that will prolong their freshness or usability, and preferably having a removable airtight lid 12. Preferably, the lid 12 seals the storage container 14 in such a manner as to eliminate or reduce the amount of oxygen, heat, light and moisture that come in contact with any products stored in the container 14. A container 14 made of glass is optionally provided with UV protection such as a UV coating on the outer surface of the glass, or it may include a reflective lining (not shown) placed inside the container 14 to reduce the amount of light and heat that enters the container 14.

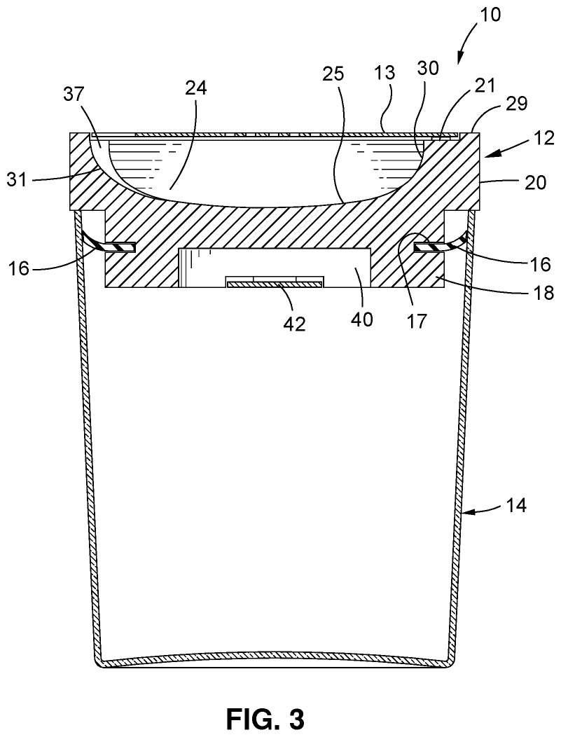

As best shown in FIGS. 2 and 3, the removable lid 12 has an upper portion 20 with relatively larger outer dimensions matching the outer dimensions of the storage container 14, and a lower portion 18 having slightly smaller dimensions matching the inner dimensions of the storage container 14. This allows the lower portion 18 of the lid 12 to be inserted snugly into the open top end 11 of the storage container 14, leaving the upper portion 20 of the lid 12 exposed above the storage container 14. Arranged to surround the lower portion 18 of the lid 12 is a silicone sealing ring 16 which may be seated in an annular groove 17 formed in the lower portion 18 of the lid. When the lower portion 18 of the lid 12 is inserted into the open end 11 of the storage container 14, the sealing ring 16 forms an air-tight seal to protect whatever contents the container 14 may contain. The lid is preferably made of wood, metal, plastic or another material.

As best shown in FIGS. 2-4, the lid 12 preferably has a cavity 24 formed in its upper exterior surface 29, which is defined by a cavity floor 25 and sidewall 30. The cavity 24 is preferably concave in shape with a uniform curvature. In a preferred embodiment, the cavity 24 has a circular opening 27 at the upper surface 29 of the lid 12.

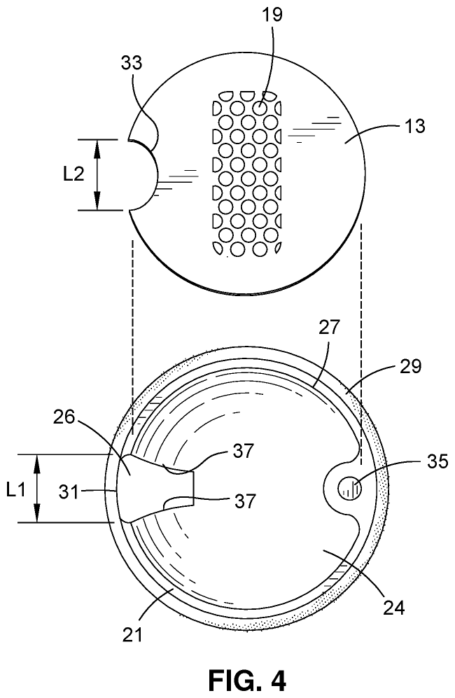

As best shown in FIGS. 2 and 4, an outward notch 31 is formed along a short length L1 (preferably about 10 mm-20 mm in length) of the cavity 24 to form a sloping channel or ramp 26 which extends down the sidewall 30 toward the floor 25 of the cavity 24 for conveying and dispensing material stored in the cavity. By shaking the lid 12 and tilting the system 10 to the side, any ground herb or other material contained in the cavity 24 may be directed into the channel 26, and thence, with further shaking, caused to pass along the channel and leave the cavity 24 via the notch 31. The channel 26 gives the user the ability to control the ground herb by directing the flow of material out of the cavity 24, confined by the sidewalls 37 of the channel 26 (see FIG. 3).

As best shown in FIGS. 1-2, a removable cover plate 13 is provided to at least partially cover the opening 27 to the cavity 24. The cover plate 13 preferably includes a grinding area 15 for grinding herb and similar material. Various types of grinders are known in the art and can be used, including the grinders shown and described in U.S. Pat. No. 10,820,755 (which is incorporated herein by reference). In use, herb material may be scraped over the grinder 15, and ground particulates will fall through openings 19 in the grinder to be collected in the cavity 24 which acts as a storage bowl for temporary storage of the ground particulates. The cavity 24 also can be used as a small mixing bowl or ashtray.

In a preferred embodiment, the cover plate 13 may be circular, and of a smaller diameter than the upper portion 20 of the lid 12, to fit into an annular recess 21 formed in the upper surface 29 of the lid. The outer edge of the plate 13 is preferably provided, over a short length L2, with a rounded indentation or inward notch 33 cut into the edge of the plate, preferably of the same magnitude as the short length L1. When the plate 13 is placed in position on top of the lid 12, it partially covers the cavity 24, and the inward notch 33 in the plate 13 aligns with the outward notch 31 in the cavity 24 to form an aperture 34 suitably large for a user to insert a finger, snag the edge of the plate 13, and pull up the plate to remove it from the lid 12. This gives free access to the cavity 24 when the plate is lifted up, and when the plate is dropped down, the aperture 34 allows any ground herb inside the cavity to be controllably shaken out of the cavity 24 through the aperture 34 via the channel 26. In a preferred embodiment, the cover plate 13 is formed of metal, and a magnet 35 is provided at a location along the annular recess 21 to hold the metal plate in a closed position on the lid 12. The plate 13, being metal, is urged by the magnet 35 to remain in its closed position in relation to the lid 12 until it is pulled away by the user as described above.

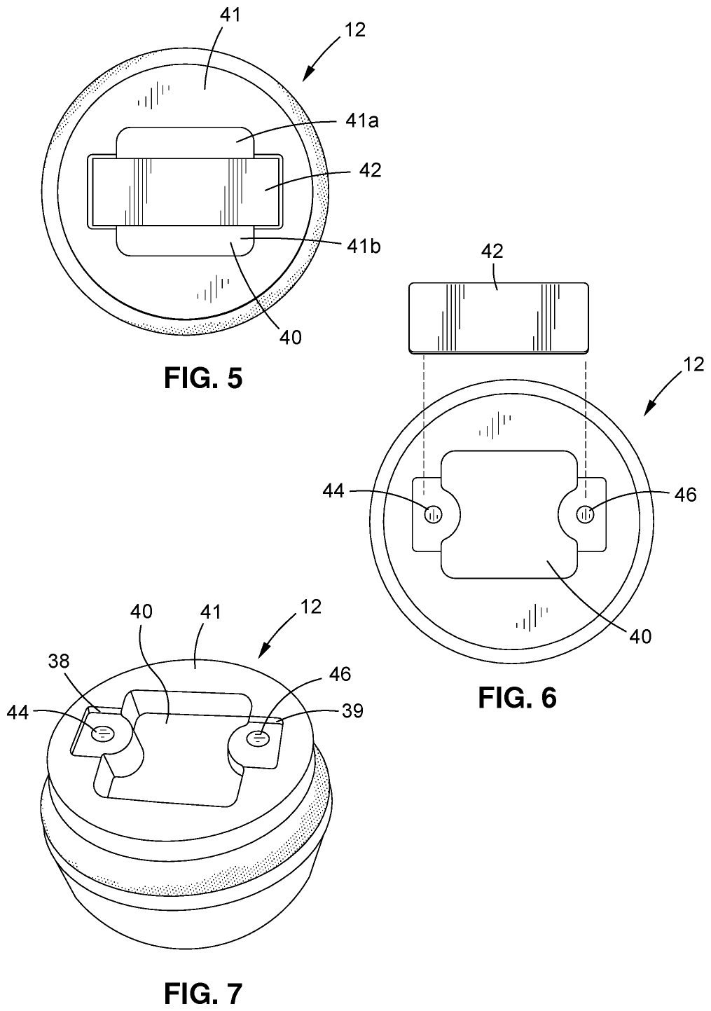

In another aspect of the invention, as best understood with reference to FIGS. 5-7, a bottom surface 41 of the lid 12 includes a recessed compartment 40 which is sized to be able to receive a small amount of humidity stabilizer, which is a conventional product normally contained in a small porous sachet (not shown). A metal retaining plate 42, preferably rectangular in shape, extends across the opening to the compartment 40 and is removably attachable preferably by magnetic attraction to small magnets 44, 46 embedded into the bottom surface 41 of the lid 18 on each side of the compartment 40, as best shown in FIG. 6, so that, when attached, the recessed compartment 40 is at least partially closed by the retaining plate. In a preferred embodiment, small openings 41a, 41b are left at the sides of the compartment 40 (FIG. 5), to allow airflow to/from the compartment 40, while the retaining plate 42 holds the humidity stabilizer sachet (not shown) inside the compartment to prolong the freshness and quality of any herbs or other materials stored in the container 14. As an alternative option, instead of providing the openings 41a and 42b at the sides of the compartment 40, holes or perforations (not shown) can be provided in the retaining plate 42 to allow airflow to/from the compartment 40. The ends of the retaining plate 42 are preferably received within recessed areas 38, 39 surrounding the magnets 44, 46, so that the plate 42 when in place is flush with, or slightly below, the bottom surface 41 of the lid 12. In an alternate embodiment, instead of using the magnets 44, 46, the plate 42 can be held in place with a friction fit within the recessed areas 38, 39. A preferred humidity stabilizer is the Boveda 2-way humidity control, or similar device, which regulates the relative humidity to a pre-set level inside the container 14 by emitting or drawing moisture from the air inside the container to prevent stored herb or other material from accidently overdying and losing its aroma, flavor and effect while it cures inside the container.

One of ordinary skill will appreciate that the foregoing embodiment has multi-functional capabilities by virtue of having a built-in grinder, storage bowl, dispensing channel and humidifier in a single device, which allows a user to grind a selected herb or other material directly into the storage bowl 24 through the openings 19 in the cover plate 13. When there is sufficient product in the storage cavity 24, the user can then use the built-in dispensing channel 26 to pour the ground material directly into the point of intended usage. Leftover material can be stored in the container 14 at an ideal temperature and humidity condition, by removing the lid 12 and placing the unused material into the container 14 for interim storage. Securing the airtight lid 12 back into place on top of the container 14 with a humidity stabilizer in place, will help keep the material fresh inside the container 14 until time for its eventual use.

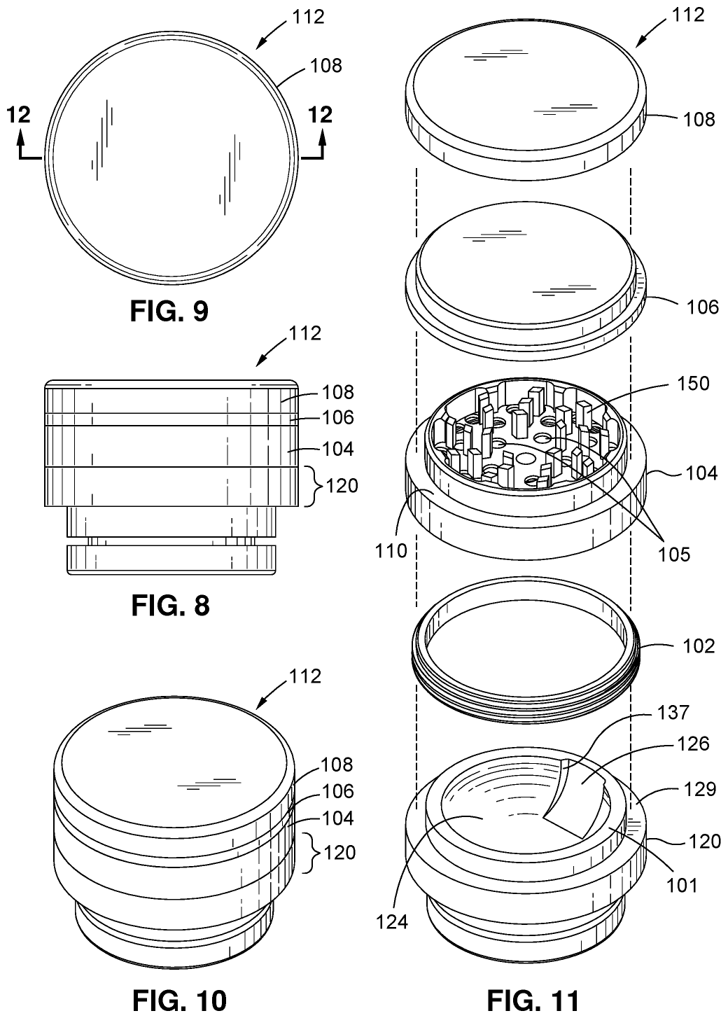

A further embodiment of the invention is shown in FIGS. 8-13. In this embodiment, a modification is made to the previous embodiment, and replaces that lid 12 with a modified lid 112 having a different grinder system mounted thereon. However, some of the features of the lid remain the same (as indicated by reference numerals in which similar elements in the second embodiment bear the same reference as in the first embodiment numerals increased in magnitude by 100).

As shown in FIGS. 8-13, the modified lid 112 includes a modified upper portion 120 which has similar features to the lid 12, except that the cover plate 13 of that embodiment is removed, and an upstanding flange 101 (FIG. 11) is formed on the upper surface 129 of the lid 112 around the opening to the cavity 124.

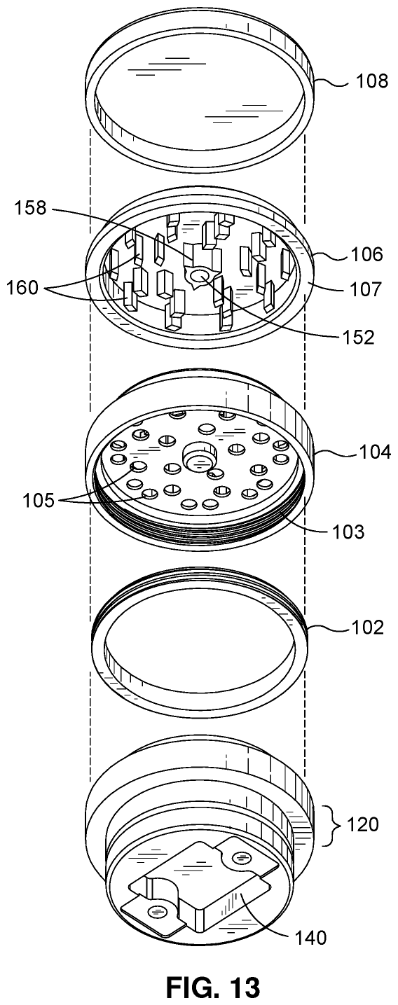

Instead of using a cover plate 13 with a stationary grinding surface 15 as in the previous embodiment, the modified lid 112 includes a rotary grinding system with opposing metal teeth. An externally threaded collar 102 fits securely around the upstanding flange 101. A rotary grinder base 104 with mating internal threads 103 (FIG. 13), is removably threaded onto the collar 102. The base 104 includes a plurality of upwardly extending teeth 150. Between the teeth 150, holes 105 are formed in the base 104 to permit ground herb to fall through the base 104 into the cavity 124 which is substantially the same as the cavity 24 of the previous embodiment, and includes a similar dispensing channel 126 as the channel 26 in the first embodiment.

Instead of using the externally threaded collar 102, the grinder base 104 can be connected directly to the lid 112 by providing mating screw threads on the upstanding flange 101 and base 104. For example, male screw threads provided on the exterior of the base 104 can mate with female screw threads provided on the inner surface of the flange 101.

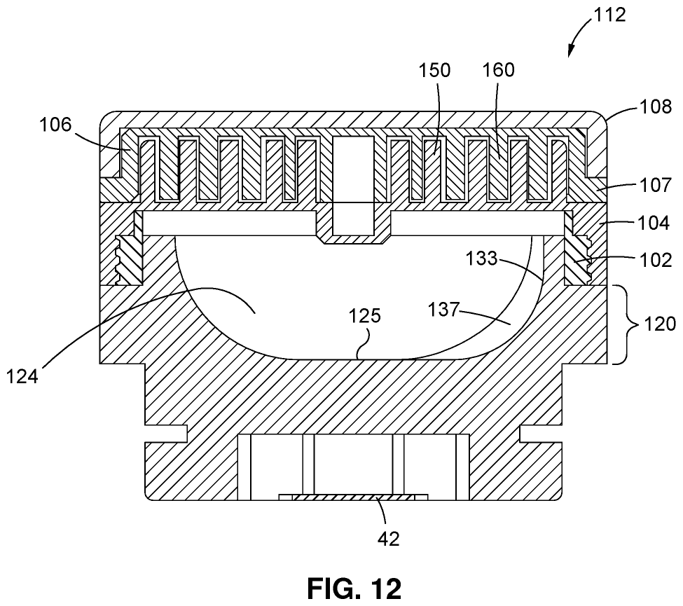

After the base 104 is installed on the threaded collar 102, a grinder top 106 is installed on the base 104. The grinder top 106 has a radially outward annular flange 107 that rests on an upper surface 110 of the grinder base 104 to permit the top 106 to rotate in relation to the base 104. The top 106 includes a plurality of downwardly extending teeth 160, which are positioned to slide between the upwardly extending teeth 150 on the base 104 when the top 106 is rotated in relation to the base 104 (see FIG. 12). A decorative cap 108 is shaped to fit over the grinder top 106 for aesthetic purposes. Both the grinder top 106 and grinder base 104 are preferably made of metal, and a magnet 152 is disposed on the end of a downwardly extending post 155 centrally located in the grinder top 106 to hold the grinder top 106 and grinder base 104 together, while permitting relative rotation therebetween.

In use, when the modified lid 112 is assembled as described, the user may remove the grinder top 106 and deposit a small amount of herb between the upwardly extending teeth 150 on the grinder base 104, thereafter installing the grinder top onto the base. By rotating the grinder top 106 in relation to the base 104, the meshing teeth 150, 160 will grind the herb in a shearing action, and the ground pieces will fall through the holes 105 into the cavity 124.

Thereafter, the user may dispense the ground herb from the cavity 124, by unscrewing the grinder base 104 from the threaded collar 102, to expose the cavity 124. By gently shaking and tilting the lid 112, the ground herb can be poured from the cavity 124, in a similar manner as was done with the previous embodiment.

Variations on this second embodiments are also possible. For example, the grinder base 104 can be connected directly to the storage container 14 by providing male screw threads on the outside of the container 14 near the open end 11. Alternatively, female screw threads can be provided inside the container 14 preferably near the open end 11 to mate with corresponding male screw threads (not shown) formed on the outer surface of the grinder base 104. With either variation, the bottom part of the lid 112 including the cavity 124 and dispensing channel 126 can be eliminated.

Although preferred illustrative variations of the present invention are described above, it will be apparent to those skilled in the art that various changes and modifications may be made thereto without departing from the spirit of the invention. The present embodiments are, therefore, to be considered in all respects as illustrative and not restrictive, while the scope of the invention is set forth in the claims that follow.

We claim:

1. A system for managing herbs, comprising:
a storage container having an opening for accessing an interior chamber of the container;
an exterior portion of the container having a surface that defines a cavity for collecting ground material, the cavity having an opening and a generally concave shape with a floor and a sidewall; and
further including a removable grinder attached to the container to at least partially close the opening to the cavity and allow ground material to fall from the grinder into the cavity.

2. The system of claim 1, wherein:
the storage container includes a removable lid having an upper portion and a lower portion;
the lower portion of the lid having a size that can fit snugly inside the opening of the container to form a seal;
the upper portion of the lid having an upper surface that defines said cavity; and
further including a removable cover plate configured to at least partially close the opening to the cavity, the cover plate including said grinder for grinding herb material.

3. The system of clam 2, wherein the removable cover plate is configured to rest in an annular recess on the upper surface of the lid.

4. The system of claim 2, wherein the cavity has an outward notch, smaller in area than the cavity, extending down the sidewall toward the floor to define a sloping ramp for dispensing material out of the cavity.

5. The system of claim 2, wherein over a short length, the cover plate has an inward notch in an edge of the plate which aligns with the outward notch in the cavity to form a space for receiving a user's fingertip to allow the user to grip the cover plate with his fingertip and remove the cover plate from the lid.

6. The system of claim 2, further including at least one magnet which is embedded in the lid for holding the cover plate in a secure position.

7. The system of claim 2, wherein a plurality of holes is provided in the cover plate to allow ground herb to fall through the cover plate into the cavity.

8. The system of claim 2, wherein a seal ring surrounding the lower portion of the lid provides an airtight seal between the lid and the container.

9. The system of claim 2, wherein:
the lower portion of the lid has a lower surface with a recessed compartment sized to receive a humidity stabilizer; and
a removable retainer plate sized to at least partially cover the recessed compartment is provided, the removable retainer plate being attachable to the lower portion of the lid by at least one magnet embedded in the lower portion of the lid.

10. The system of claim 1, wherein the grinder is a rotary grinder removably attached to the container.

11. The system of claim 10, wherein the rotary grinder is removably attached to the container by mating screw threads on the container and grinder.

12. The system of claim 2, wherein the storage container is a wide-mouth glass jar.

13. The system of claim 2, wherein the lid is made of wood.

14. The system of claim 2, wherein the cover plate is made of metal.

15. A system for managing herbs, comprising:
a storage container having an open end and a closed end;
screw threads provided around the open end of the storage container;
a rotary grinder having an upper portion and a lower portion; and
screw threads provided around the lower portion of the rotary grinder for engaging with the screw threads on the open end of the storage container, to permit the rotary grinder to be removably attached to the open end of the storage container.
